(19) United States
(12) Patent Application Publication
(10) Pub. No.: US 2026/0370663 A1
(43) Pub. Date: Nov. 19, 2026

(54) GLOBAL SIGNAL ANALYTICS

(71) Applicant: Micro Focus LLC, Wilmington, DE (US)

(72) Inventors: Mark Bosco Fernandes, North York (CA); Markus Sell, Munich (DE)

(73) Assignee: Micro Focus LLC, Wilmington, DE (US)

(21) Appl. No.: 19/659,889

(22) Filed: Apr. 27, 2026

Related U.S. Application Data
(63) Continuation of application No. 19/001,175, filed on Dec. 24, 2024.
Application No. 19/001,175 is a continuation of application No. 18/520,551, filed on Nov. 27, 2023, now abandoned.

(51) Int. Cl. H04L 9/40

(52) U.S. Cl. CPC H04L 63/1416; H04L 63/1425; H04L 63/1466

(57) ABSTRACT

Attacks on a first network can be targeted to the first network or components on the first network, or can be untargeted, wherein other networks each receive the same attack. By determining if an attack is targeted or untargeted, a more appropriate response may be initiated to protect the private network. A targeted attack may indicate that an actor, which may be an unfriendly state-sponsored actor, is directing their efforts to penetrate a particular network. In response, additional efforts to protect the network and/or other assets having common ownership of the network may be reinforced in anticipation of a broader attack.

### CROSS REFERENCE TO RELATED APPLICATION

The present application is a continuation of U.S. Patent Application No. 19/001,175, filed Dec. 24, 2024, entitled "GLOBAL SIGNAL ANALYTICS," which is a continuation of U.S. Patent Application No. 18/520,551, filed Nov. 27, 2023, both of which are incorporated herein by this reference in its entirety.

### FIELD OF THE DISCLOSURE

The invention relates generally to systems and methods for detecting and responding to attacks on a network and particularly to detected targeted and non-targeted attacks and responding thereto.

### BACKGROUND

Today, traditional security operation technologies require significant human capital and deep technical knowledge to adequately provide security monitoring and adversary detection capabilities. Traditional security operation technologies further require complex data collection and integration in many scenarios, causing political and data protection concerns or other concerns and a clash of responsibilities.

Data at hand is hard to interpret and requires significant human involvement to make sense of data sources, data types, and results produced.

Furthermore, traditional solutions have a very high degree of dependency on the amount, type, and volume of collected data in order to drive meaningful conclusions. Storing that data is another commercial complexity.

Data available to a customer (e.g., owner/operator of a private network) only provides a limited view of current adversary activity. Specifically, traditional approaches only help to identify malicious activity when a cyber-criminal is already in a network, and may have already caused damage to devices or data.

### SUMMARY

Prior art solutions in the market are reactive and require a significant amount and various types of data. The data is often difficult or impossible to collect due to the complex processes required, the uncertain role of responsibility between customers, operators, and vendors, and technical constraints in customers' IT infrastructure. Prior art solutions collect sensor data but only see what happens within a network (e.g., a corporate IT infrastructure), thus being reactive. Prior art solutions require complex data integration, which is often not available due to denied permissions or the computational and storage resources required.

These and other needs are addressed by the various embodiments and configurations of the present invention. The present invention can provide a number of advantages depending on the particular configuration. These and other advantages will be apparent from the disclosure of the invention(s) contained herein.

Systems and methods are provided herein that provide enhanced proactive network security that omit the need for complex data integrations or highly specialized skills to interpret information produced by the solution. Certain embodiments are directed to the data retrieved, how the data is retrieved, the type of data analyzed, the analysis of the data, and the production and the presentation of results.

In one embodiment, signals-based analytics are provided. As a benefit, blind spots in a network are removed, providing a better understanding of how adversaries are targeting a network's public IP address space.

In another embodiment, solutions provided herein may be implemented as a "Software as a Service" (SaaS) and operated remotely. The solution comprises data harvesting, data analytics, results presentation, and threat mitigation. The data harvesting components retrieve necessary information (global signals) from a partner application programming interface (API) and send the signals to the data analytics component. Additionally or alternatively, contextual information is also collected and combined with the global signals in order to make better sense and make results easier to interpret. The analytics component utilizes specialized methods on the combinations of the data signals and provides analytics results. Additionally or alternatively, threat mitigation is implemented to remove a threat and/or enhance resistance to a threat.

Implementation of one or more embodiments herein provides advantages and advances the state of the art. In particular: the need for complex and high-volume data integration is avoided; custom-made analytics are applied to global signal data, which provides unique insights into data only achievable by the combination of the signals used and analytics provided; additional visibility to a network is obtained from global signals; customizable visual presentations are available; and detecting and managing actual threats in real-time is provided, rather than potential vulnerabilities and post-fact attacks.

Exemplary aspects are directed to:
A method for protecting an internal network, comprising: receiving a first set of signals from an internal component of the internal network; upon determining that the first set of signals comprises an attack, receiving a second set of signals from an external component of an external network discrete from the internal network; upon determining that the second set of signals comprises the attack, identifying the attack as untargeted; upon determining that the second set of signals is absent the attack, identifying the attack as targeted; and upon the attack being identified as targeted, initiating a targeted attack mitigation response on the internal network.
A system for protecting an internal network, comprising: a network component comprising a processor and a computer memory having instructions executed by the processor and a network interface to the internal network and a public network; wherein the network component: monitors a first set of signals from an internal component of the internal network; upon determining that the first set of signals comprises an attack, receives a second set of signals from an external component of an external network discrete from the internal network; upon determining that the second set of signals comprises the attack, identifies the attack as untargeted; upon determining that the second set of signals is absent the attack, identifies the attack as targeted; and upon the attack being identified as targeted, initiates a targeted attack mitigation response on the internal network.
A system for protecting an internal network, comprising: a network component comprising a processor and a computer memory having instructions executed by the processor and a network interface to the internal network and a public network; wherein the network component: monitors a first set of signals from an internal component of the internal network; upon determining that the first set of signals comprises an attack, receives a second set of signals from an external component of an external network discrete from the internal network; upon determining that the second set of signals comprises the attack, identifies the attack as untargeted and executing a first set of responses; and upon determining that the second set of signals is absent the attack, identifies the attack as targeted and executing a second set of responses in addition to the second set of responses; and wherein the second set of responses comprises initiating a protection on at least one device of the internal network that was not subject to the attack.

Any of the above aspects:
Wherein receiving the second set of signals from the external component of the external network comprises receiving a plurality of the second set of signals from a corresponding plurality of components corresponding to a plurality of external networks; upon determining that a previously determined threshold number of the plurality of the second set of signals comprise the attack, identifying the attack as untargeted; and upon determining that the previously determined threshold number of the plurality of the second set of signals are absent the attack, identifying the attack as targeted.
Further comprising: identifying an origin of the attack; identifying attack types associated with the origin of the attack; and applying the targeted attack mitigation response to attack components of the internal network that correspond to an attack type of the attack.
Wherein identifying the origin of the attack comprises identifying a country of origin of the attack.
Wherein identifying the origin of the attack comprises identifying an Internet Protocol (IP) address of origin of the attack.
Wherein identifying the origin of the attack comprises identifying a network port of the attack associated with the origin of the attack.
Wherein the internal network and the external network are interconnected exclusively via a public network.
Wherein the network component: receives the second set of signals from the external component of the external network, comprising receiving a plurality of the second set of signals from a corresponding plurality of components corresponding to a plurality of external networks; upon determining that a previously determined threshold number of the plurality of the second set of signals comprise the attack, identifies the attack as untargeted; and upon determining that the previously determined threshold number of the plurality of the second set of signals are absent the attack, identifies the attack as targeted.
Wherein the network component: identifies an origin of the attack; identifies attack type associated with the origin of the attack; and applies the targeted attack mitigation response to attack components of the internal network that correspond to the attack type.
Wherein the origin of the attack, comprising a country of origin of the attack. Wherein the origin of the attack comprises an Internet Protocol (IP) address of origin of the attack.
Wherein the origin of the attack comprises a network port of the attack associated with the origin of the attack.
Wherein the internal network and the external network are interconnected exclusively via the public network.
Wherein the network component: receives the second set of signals from the external component of the external network comprises receiving a plurality of the second set of signals from a corresponding plurality of components corresponding to a plurality of external networks; upon determining that a previously determined threshold number of the plurality of the second set of signals comprise the attack, identifies the attack as untargeted; and upon determining that the previously determined threshold number of the plurality of the second set of signals are absent the attack, identifies the attack as targeted.
Wherein the network component: identifies an origin of the attack; identifies an attack type associated with the origin of the attack; and applies a targeted attack mitigation response to attack components of the internal network that correspond to the attack types.
Wherein the internal network and the external network are interconnected exclusively via the public network.

A system on a chip (SoC) including any one or more of the aspects of the embodiments described herein.

One or more means for performing any one or more of the above aspects or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases "at least one," "one or more," "or," and "and/or" are open-ended expressions that are both conjunctive and disjunctive in operation. For example, each of the expressions "at least one of A, B, and C," "at least one of A, B, or C," "one or more of A, B, and C," "one or more of A, B, or C," "A, B, and/or C," and "A, B, or C" means A alone, B alone, C alone, A and B together, A and C together, B and C together, or A, B, and C together.

The term "a" or "an" entity refers to one or more of that entity. As such, the terms "a" (or "an"), "one or more," and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a data flow in accordance with embodiments of the present disclosure;

FIG. 3 depicts a process in accordance with embodiments of the present disclosure; and

FIG. 4 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

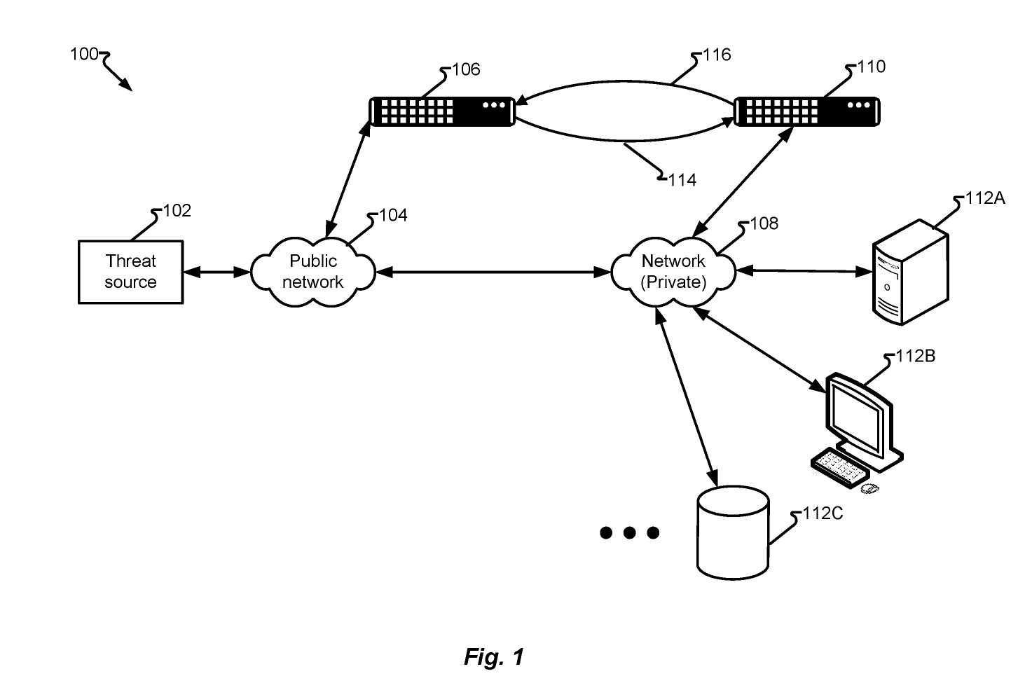

FIG. 1 depicts system 100 in accordance with embodiments of the present disclosure. In one embodiment, threat source 102 executes an attack on private network 108 alone, namely, a targeted attack on private network 108. A targeted attack on private network 108 is distinguished from a non-targeted attack in that the attack is directed to private network 108 or a component attached to private network 108, such as first network component 110 and/or one or more network attached devices 112A-C. In contrast, a non-targeted attack may be an attack that originates from threat source 102 that is directed to private network 108 and a component outside of private network 108, such as network component 106. Second network component 106 may comprise a discrete domain name or Internet Protocol (IP) network address different from any of private network 108 or a range of IP addresses utilized by components of private network 108. Generally, and in one embodiment, second network component 106 and first network component 110 will have different ownership and/or management entities.

An attack may be known to originate from threat source 102 as a specific source, as a category of sources, or as an exclusion (e.g., a source other than a particular known source). While system 100 illustrates second network component 106 as a single device and a single target of an attack, second network component 106 may be a portion of another network (similar to private network 108) having its own private communication pathways and attached devices. Accordingly, it should be appreciated that second network component 106 may be implemented as a plurality of devices whether individual network attached devices or component of additional secondary private networks, each of which being distinct from private network 108. As a benefit, the degree to which a particular attack is determined to be targeted or non-targeted may be more precise. For example, if second network component 106 is implemented on each of a thousand secondary private networks, an attack may be observed on private network 108 and none, a small number, a large number, or all of the thousand secondary private networks. As a result, and in another embodiment, the degree to which the attack is targeted may be determined and mitigated accordingly.

To avoid unnecessarily complicating the figures and resulting description, second network component 106 is described as being a single device attached to public network 104, such as the Internet. However, it should be appreciated that second network component 106 may be one of many components interconnected via a secondary private network, such as a topology similar to private network 108 and comprising devices similar to network attached devices 112A-C. In another embodiment, second network component 106 provides some, all, or indicia (e.g., type information, source information, etc.) of network signals 114 received to first network component 110. Network signals may be embodied as data packets, portions of data packets, or aggregation across a plurality of data packets. Additionally or alternatively, network signals 114 may be limited to signals that are known to be a threat or determined, such as by second network component 106, as potentially comprising a threat, such as upon receiving a signal by second network component 106 that has no apparent useful value to second network component 106 or another device of a secondary network comprising second network component 106.

As a benefit of providing network signals 114 to first network component 110, second network component 106 may detect attacks to second network component 106 (or interconnected devices) that may not exist. For example, second network component 106 may be a router interconnected to a "Brand X" server. In the prior art, an attack received at second network component 106, on the non-existent "Brand Y" server, may be ignored or omitted from log files. However, by providing network signals 114 identifying the attack, first network component 110 may determine that a non-targeted attack on "Brand Y" servers has recently been launched and initiate mitigation actions to evaluate and protect vulnerable devices (such as when network attached device 112A is a "Brand Y" server) and/or notify second network component 106 in step 116 and/or other networks, of the ongoing attack. For example, a mitigation action may initiate enhanced monitoring, apply additional restrictions (e.g., disable previously permitted features or authorizations), force a restart (load pending firmware updates), or replace or disable the target device.

In another embodiment, second network component 106 may be a third-party component operable to receive and/or monitor attacks. For example, second network component 106 may be a component installed at a different location and subject to attacks and/or networked to monitor communications comprising attacks directed to other components at the different location. The location may be different in terms of country, type of industry at the location, and/or owning/controlling entity at that location. Accordingly, if a hostile attack is originating from an unfriendly nation (an example of threat source 102) and directed to both first network component 110 and second network component 106, when second network component 106 is located or controlled by a close ally with the unfriendly nation, the attack on first network component 110 is untargeted. Knowing an attack is, or is not, also being directed to second network component 106 (or another component at the different location monitored by second network component 106) may be determined and reported by a third-party operator of second network component 106. The third-party may be a threat assessment entity, signal partner, tor server, or other entity having second network component 106 deployed to receive attacks or attack information and report attack information as a portion of network signals 114 to first network component 110 and/or one or more network attached devices 112A-C. Additionally or alternatively, threats or attacks received by first network component 110 may be provided to the third-party(ies) operating second network component 106.

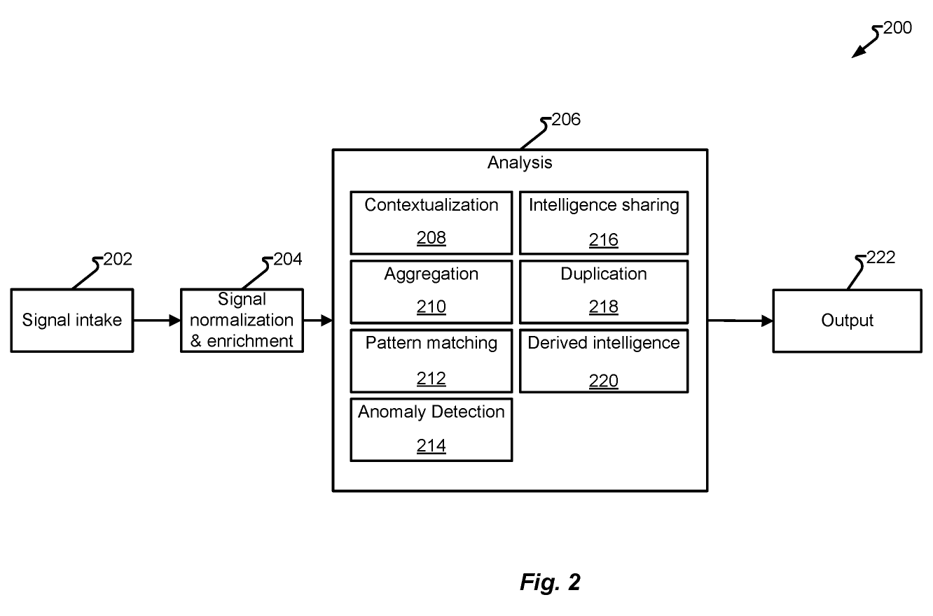

FIG. 2 depicts data flow 200 in accordance with embodiments of the present disclosure. In one embodiment, data flow 200 is embodied as machine-readable instructions maintained in a non-transitory memory that when read by a machine, such as a processor of a server, cause the machine to execute the instructions and thereby execute data flow 200. The processor of the server may include, but is not limited to, first network component 110.

In one embodiment, data flow 200 begins and, in signal intake 202, data signals are received and/or retrieved. Optionally, signals may be selected from a pool of signal types determined based on particular services, devices, and threats appropriate for a given private network (e.g., private network 108). Signals may include one or more of:
DNS Queries
PDNS Name-to-Address
High Interaction Environment Observed DDoS Attacks
High Interaction Environment BARS Botnet Controllers
DNS Derived Domains
eBGP Global Routing Updates
eBGP History
eBGP Routing Snapshot
Flow
Banners
JA3 Fingerprint
OS Fingerprinting
Open Ports
Proxies
SIP Info
SSH Info
Compromised Hosts
Spam Headers
ICS Honeypot
Beacons
RDP Traffic
User Agent Strings
User Agent CPU and Compiler
User Agent Language
High Interaction Environment Observed Infected Victims
OS Fingerprinting
x509 Certs
Cowrie (SSH and Telnet Honeypot)
Dionaea (Malware Capturing Honeypot)
URLs
Anti-Paste
IPV4
HASH
FQDN
Tor Exit Identification
Top Domains
Top User Agent Strings
Top x509
Top ASN
Top Email Watch Senders

Next, signal normalization and enrichment 204 convers signal data into standardized formats and/or standardized timeframes (e.g., once every 24 hours). For example, data may be populated with additional information (e.g., customer site, equipment, etc.).

Next, analysis 206 aggregates outputs from one or more individual analysis operations including, but not limited to, contextualization 208, aggregation 210, pattern matching 212, anomaly detection 214, intelligence sharing 216, duplication 218, and/or derived intelligence 220. In one embodiment, analysis 206 determines if threats are targeted or non-targeted. For example, if an attack is conducted against private network 108 but not second network component 106, threat source 102 is likely explicitly targeting private network 108. In contrast, if an attack is observed at second network component 106 and private network 108 (e.g., first network component 110), then an attack is determined to be non-targeted. In another embodiment, a threat may be originating from a known geographical location. Accordingly, threat source 102 may be identified as an individual, an organization, or a governmental agency, such as a particular actor nation state (ASN). For example, if a hostile nation (e.g., threat source 102) is observed attacking private network 108, but not second network component 106, then the attack is determined to be targeted and the attack may be an indicator of additional attacks having been made, in progress, or soon to be initiated. In contrast, if second network component 106 is also attacked, then the hostile nation is likely exploring for targets and not specifically targeting any particular network.

Analysis 206 may determine if an attack observed at one component (e.g., first network component 110) is related to an attack on another component (e.g., second network component 106). A number of attacks on a number of targets may have differences. Analysis 206 determines if there are sufficient similarities or signatures in two or more attacks to conclude a common threat source 102. More specifically, analysis 206 considers the IP address of an attack and any known information associated with the IP address (e.g., previous attacks) as well as the ASN and/or latitude and longitude coordinates (e.g., country, geographic region, building, location of actor, etc.).

If threat source 102 is not identified by location, a pattern (determined by protocol and/or service) utilized may indicate a risk and/ or aspects of the source or target of the attack. As a result, threat source 102 location may be identified. Output 222 saves and/or notifies recipients, such as to automatically initiate a mitigation response that may affect a network being specifically targeted or provide an indicator of a broader attack, which may include other targets (e.g., physical infrastructure, personnel, personal devices, etc.).

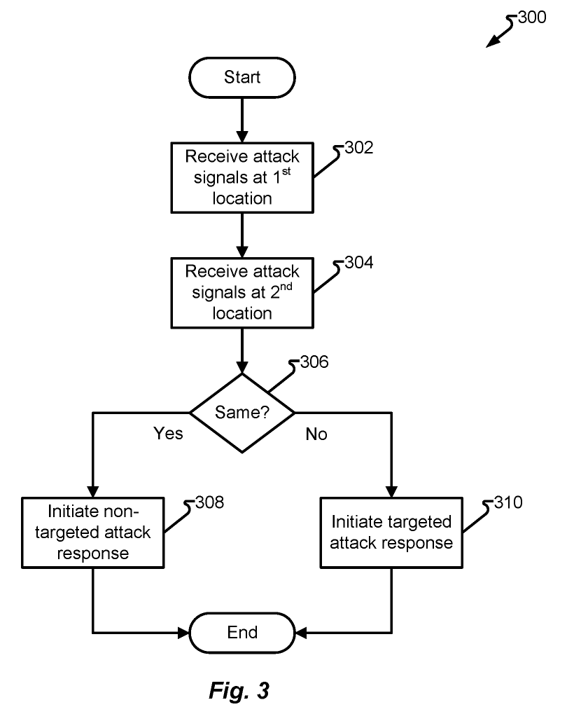

FIG. 3 depicts process 300 in accordance with embodiments of the present disclosure. In one embodiment, process 300 is embodied as machine-readable instructions maintained in a non-transitory memory that, when read by a machine, such as a processor of a server, cause the machine to execute the instructions and thereby execute process 300. The processor of the server may include, but is not limited to, first network component 110.

Process 300 begins and, in step 302, attack signals of an attack is received at a first location. The first location is a networked component of a private network 108, which may include an endpoint node (e.g., a computer, server, etc.) or a networking component (e.g., a router, switch, firewall, etc.). Private network 108 may comprise a number of ongoing protections (e.g., firewall, encryption, authentications, etc.) that are continually implemented to thwart an untargeted attack. Step 304 receives attack signals indicating that a second location is being attacked. The second location may comprise one or more components of a second private network or a single network attacked device, such as second network component 106. Optionally, step 304 may comprise a large number of second locations, such as to provide more granularity as to when a particular untargeted attack begins and from where.

Test 306 determines if the attacks on the first and second locations are the same and, if true, processing continues to step 308. An attack may be considered the same attack if identified from a common source (e.g., nation state, hacker group, geographic location, location of actor, etc.). If test 306 determines the attacks on the first and second locations are the same attack, then the attack is not targeted and, in step 308, a non-targeted attack response may be initiated or continued. For example, if a level of untargeted attacks has increased, then prompts may be triggered to cause passwords to expire and force updating of passwords, and/or another general response.

If test 306 determines the attacks are not the same, then the attack is determined to be targeted, and processing continues to step 310. Step 310 initiates a set of responses due to a targeted attack. The targeted attack may indicate that the enterprise (e.g., a company, governmental agency, etc.) that owns or operates the private network subject to the attack (observed in step 302) is explicitly being targeted. As a result, step 310 may initiate extra measures to protect the private network and/or other assets. For example, a more aggressive (and difficult for users) password program may be initiated to protect networked assets, Internet access policies may be made more restrictive, etc. Additionally or alternatively, other assets, such as buildings, may have extra security measures applied.

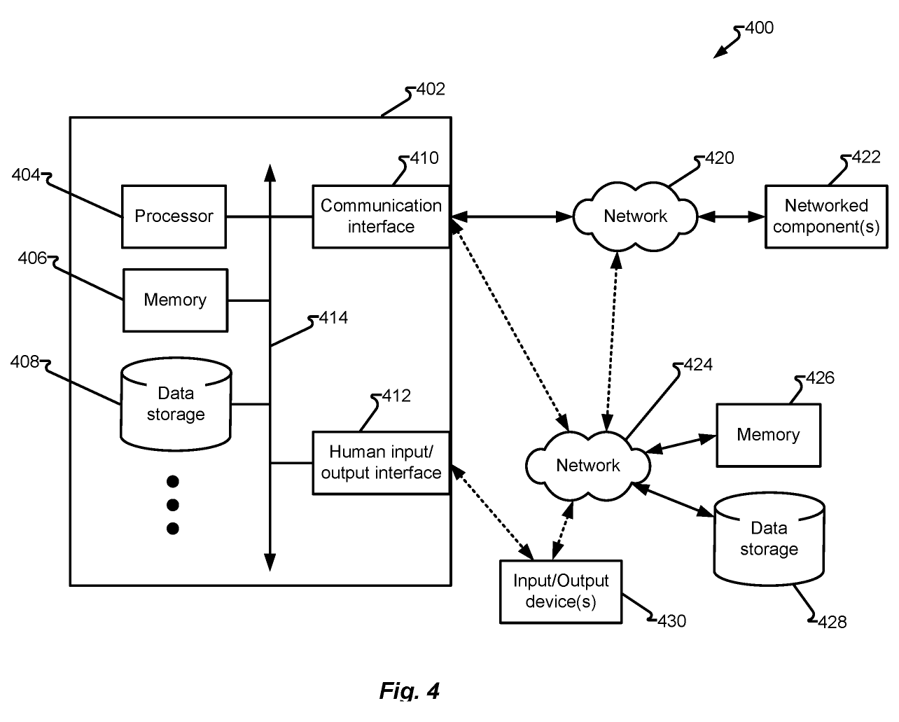

FIG. 4 depicts device 402 in system 400 in accordance with embodiments of the present disclosure. In one embodiment, first network component 110 and second network component 106 may be embodied, in whole or in part, as device 402 comprising various components and connections to other components and/or systems. The components are variously embodied and may comprise processor 404. The term "processor," as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., "cloud", farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Public network 104 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422.

Additionally or alternatively, one or more other networks may be utilized. For example, private network 108 may be embodied as network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, "cloud," etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), "cloud", multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., "cloud" based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as "the cloud," but may include a public, private, dedicated, shared and/or other service bureau, computing service, and/or "server farm."

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, "cloud" or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable "source code" software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for protecting an internal network, comprising:
receiving a first set of signals from an internal component of the internal network;
upon determining that the first set of signals comprises an attack, receiving a second set of signals from an external component of an external network discrete from the internal network;
transforming the first set of signals and the second set of signals into a standardized data structure to generate a normalized first set of signals and a normalized second set of signals;
analyzing the normalized first set of signals and the normalized second set of signals to determine a degree of similarity between the normalized first set of signals and the normalized second set of signals;
upon determining that the degree of similarity satisfies a sufficiency similarity threshold, identifying the attack as untargeted;
upon determining that the degree of similarity fails to satisfy the sufficiency similarity threshold, identifying the attack as targeted; and
upon the attack being identified as targeted, initiating a targeted attack mitigation response on the internal network.

2. The method of claim 1, wherein:
receiving the second set of signals from the external component of the external network comprises receiving a plurality of the second set of signals from a corresponding plurality of components corresponding to a plurality of external networks;
upon determining that a previously determined threshold number of the plurality of the second set of signals comprise the attack, identifying the attack as untargeted; and
upon determining that the previously determined threshold number of the plurality of the second set of signals are absent the attack, identifying the attack as targeted.

3. The method of claim 1, further comprising:
identifying an origin of the attack;
identifying attack types associated with the origin of the attack; and
applying the targeted attack mitigation response to attack components of the internal network that correspond to an attack type of the attack.

4. The method of claim 3, wherein identifying the origin of the attack comprises identifying a country of origin of the attack, identifying an IP address of origin of the attack or identifying a network port of the attack associated with the origin of the attack.

5. The method of claim 1, wherein the internal network and the external network are interconnected exclusively via a public network.

6. The method of claim 1, wherein the targeted attack mitigation response includes updating passwords for users of the internal network.

7. The method of claim 1, wherein the first set of signals is also associated with the internal component under a first ownership or management entity and the second set of signals is also associated with the external component under a second ownership or management entity different from the first ownership or management entity.

8. A system for protecting an internal network, comprising:
a network component comprising a processor and a computer memory having instructions executed by the processor and a network interface to the internal network and a public network, wherein the network component:
monitors a first set of signals from an internal component of the internal network;
upon determining that the first set of signals comprises an attack, receives a second set of signals from an external component of an external network discrete from the internal network;
transforms the first set of signals and the second set of signals into a standardized data structure to generate a normalized first set of signals and a normalized second set of signals;
analyzes the normalized first set of signals and the normalized second set of signals to determine a degree of similarity between the normalized first set of signals and the normalized second set of signals;
upon determining that the degree of similarity satisfies a sufficiency similarity threshold , identifies the attack as untargeted;
upon determining that the degree of similarity fails to satisfy the sufficiency similarity threshold, identifies the attack as targeted; and
upon the attack being identified as targeted, initiates a targeted attack mitigation response on the internal network.

9. The system of claim 8, wherein the network component:
receives the second set of signals from the external component of the external network, comprising receiving a plurality of the second set of signals from a corresponding plurality of components corresponding to a plurality of external networks;
upon determining that a previously determined threshold number of the plurality of the second set of signals comprise the attack, identifies the attack as untargeted; and
upon determining that the previously determined threshold number of the plurality of the second set of signals are absent the attack, identifies the attack as targeted.

10. The system of claim 8, wherein the network component:
identifies an origin of the attack;
identifies attack type associated with the origin of the attack; and
applies the targeted attack mitigation response to attack components of the internal network that correspond to the attack type.

11. The system of claim 10, wherein the origin of the attack comprises a country of origin of the attack, an IP address of origin of the attack or a network port of the attack associated with the origin of the attack.

12. The system of claim 8, wherein the internal network and the external network are interconnected exclusively via the public network.

13. The system of claim 8, wherein the targeted attack mitigation response includes updating passwords for users of the internal network.

14. A system for protecting an internal network, comprising:
a network component comprising a processor and a computer memory having instructions executed by the processor and a network interface to the internal network and a public network, wherein the network component:
monitors a first set of signals from an internal component of the internal network;
upon determining that the first set of signals comprises an attack, receives a second set of signals from an external component of an external network discrete from the internal network;
transforms the first set of signals and the second set of signals into a standardized data structure to generate a normalized first set of signals and a normalized second set of signals;
analyzes the normalized first set of signals and the normalized second set of signals to determine a degree of similarity between the normalized first set of signals and the normalized second set of signals;
upon determining that the degree of similarity satisfies a sufficiency similarity threshold, identifies the attack as untargeted and executing a first set of responses; and
upon determining that the degree of similarity fails to satisfy the sufficiency similarity threshold, identifies the attack as targeted and executing a second set of responses in addition to the first set of responses,
wherein the second set of responses comprises initiating a protection on at least one device of the internal network that was not subject to the attack.

15. The system of claim 14, wherein the first network component:
receives the second set of signals from the external component of the external network comprises receiving a plurality of the second set of signals from a corresponding plurality of components corresponding to a plurality of external networks;
upon determining that a previously determined threshold number of the plurality of the second set of signals comprise the attack, identifies the attack as untargeted; and
upon determining that the previously determined threshold number of the plurality of the second set of signals are absent the attack, identifies the attack as targeted.

16. The system of claim 14, wherein the network component:
identifies an origin of the attack;
identifies an attack type associated with the origin of the attack; and
applies a targeted attack mitigation response to attack components of the internal network that correspond to the attack types.

17. The system of claim 16, wherein the origin of the attack comprises a country of origin of the attack, an IP address of origin of the attack or a network port of the attack associated with the origin of the attack.

18. The system of claim 14, wherein the internal network and the external network are interconnected exclusively via the public network.

19. The system of claim 14, wherein the second set of responses further comprises updating passwords for users of the internal network.

20. The system of claim 14, wherein the first set of signals is also associated with the internal component under a first ownership or management entity and the second set of signals is also associated with the external component under a second ownership or management entity different from the first ownership or management entity.
